(19) United States
(12) Patent Application Publication
(10) Pub. No.: US 2015/0231927 A1
(43) Pub. Date: Aug. 20, 2015

(54) TIRE COMPRISING AN ADDITIONAL SIDEWALL REINFORCEMENT

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: Cedric Montezin, Clermont-Ferrand Cedex (FR)

(21) Appl. No.: 14/427,615

(22) PCT Filed: Sep. 10, 2013
(86) PCT No.: PCT/EP2013/068688

§ 371 Date: Mar. 11, 2015

Related U.S. Application Data
(60) Provisional application No. 61/739,996, filed on Dec. 20, 2012.

(30) Foreign Application Priority Data
Sep. 11, 2012 (FR) 1258512

(51) Int. Cl. B60C 9/02; B60C 9/09; B60C 9/08

(52) U.S. Cl. CPC B60C 9/02; B60C 9/08; B60C 9/09

(57) ABSTRACT

Tire comprising a radial carcass reinforcement (60) comprised of threadlike reinforcing elements (61) having an elongation at break EB_{C} and a force at break FB_{C}, placed at a pitch P_{C} and coated in rubber composition, designed so as to satisfy the relationship:

$$\frac{{FB}_{C}}{{P}_{C}} \leq 1.5 \cdot {10}^{6} \cdot \frac{( {R}_{S}^{2} - {R}_{E}^{2} )}{{R}_{T}} ,$$

Each sidewall of the tire includes an additional reinforcement (120) composed of threadlike reinforcing elements having an elongation at break EB_{A} and a force at break FB_{A}, placed at a pitch P_{A} and coated in a rubber composition, wherein each of the two additional reinforcements is designed such that

$$\frac{{FB}_{A}}{{P}_{A}} \geq 1.3 \cdot \frac{{FB}_{C}}{{P}_{C}} ,$$

and EB_{C}≧EB_{A}, the forces at break FB_{A} and FB_{C} and the elongations at break EB_{C} and EB_{A} being determined on the reinforcing elements after extraction from the cured tire.

### RELATED APPLICATIONS

This application is a U.S. National Phase application under 35 USC §371 of International Application PCT/EP2013/068688 filed Sep. 10, 2013.

This application claims the priority of French application no. 1258512 filed Sep. 11, 2012 and U.S. provisional application No. 61/739,996 filed Dec. 20, 2012, the content of all of which are hereby incorporated by reference.

### FIELD OF THE INVENTION

The present invention relates to tires for vehicles comprising textile carcass reinforcements. More particularly, it relates to the carcass reinforcements of these tires.

### BACKGROUND

When a tire rolls on the ground in the usual conditions of use (in terms of speed and load), it may sustain impacts on the tread or the sidewalls the frequency and intensity of which are often considerable. It is one of the main functions of a tire to absorb these impacts and to cushion them without the wheel of the vehicle being substantially affected, either in its movement or in its integrity.

However it happens that this absorption capability reaches its limits when the impact conditions are such that the impacted tire sidewall reaches a stop inside the tire chamber, either directly against the rim to which the tire is fitted, or more usually against another area of the tire sidewall that rests on the wheel rim. This is notably the case when the rim has an external radial protrusion from the proper seat. Such a protrusion, (usually called the “rim flange”) is normally provided to prevent the tire bead from coming off the rim under the effect of stresses of axial direction during manoeuvres of the wheel.

The impact may then transmit brief but very intense forces that can, in certain cases, reach several tonnes, to the parts of the tire and rim that are in contact, but also, beyond the rim, to the mechanical suspension attachments of the wheel assembly, and even to the body of the vehicle. They are capable of doing serious damage to the suspension members and of permanently deforming the body of the vehicle. Vehicle designers are therefore led to provide damping systems that are sufficient to prevent this damage and to design the body of the vehicles according to normally predictable extreme cases.

Unfortunately, even when the vehicle itself is properly protected, the tire subjected to this type of incident is likely to suffer consequences of the phenomenon that has just been mentioned. In the section affected by the impact, the inner wall of the tire is suddenly folded and pinched between the obstacle and the rim flange (“pinch shock”). This can cause breakage of the wall and loss of inflation pressure which, most of the time, makes it necessary to stop the vehicle. But even when the tire resists, its components may have been damaged by the incident; the expert can deduce from swellings in the sidewalls or other signs that the tire structure has been weakened and that its wall may sooner or later break under the effect of the repeated flexing of its components.

Several ways have been proposed for reinforcing tires in view of this “pinch shock” phenomenon. In most of these tires, the carcass reinforcement is anchored in the bead by means of a turn-up around an annular reinforcement structure provided in the bead. The carcass reinforcement then comprises an “main portion” which extends from one bead to the other traversing the crown of the tire, and two “wrapped-around portions” which extend from the annular reinforcement structure radially outwards. In order to reinforce a tire against “pinch shock”, it is notably known practise to extend the “wrapped-around portions” of the carcass reinforcement so that their radially outer end is sandwiched between the “main portion” of the carcass reinforcement and the crown reinforcement. This configuration is known as “shoulder lock”.

Although an architecture of the “shoulder lock” type effectively makes the tire less vulnerable to “pinch shock”, it has the drawback that it is costly while not allowing a very fine adjustment of the performance of the tire. In addition, this solution amplifies the problems of non-uniformity associated with the welds of the ply forming the carcass reinforcement because a weld is necessarily situated in the same location for the main portion and the wrapped-around portion.

### SUMMARY OF THE INVENTION

One of the objectives of the present invention is to respond to these concerns and to define a tire that can withstand the “pinch shock” phenomenon while allowing a fine adjustment of its performance and good uniformity.

This objective is achieved by a tire combining a carcass reinforcement that is “under proportioned”, that is to say proportioned so that it cannot on its own, in all the reasonably predictable conditions of use, fulfil all the functions of a carcass reinforcement (withstanding the inflation pressure, support the load, absorb the impacts), and an appropriate additional reinforcement. The functions of the carcass reinforcement are therefore performed by the combination of the carcass reinforcement itself and the additional reinforcement, which makes it possible to optimize separately each of these reinforcements and to obtain an improved cost-performance ratio.

More precisely, the objective is achieved by a tire having an axis of rotation and comprising:

two beads designed to come into contact with a mounting rim, each bead comprising at least one annular reinforcement structure having a point that is radially innermost,

two sidewalls extending the beads radially outwards, the two sidewalls coming together in a crown comprising a crown reinforcement radially surmounted by a tread;

a radial carcass reinforcement consisting of threadlike reinforcing elements having an elongation at break EB_{C} and a force at break FB_{C}, placed at a pitch P_{C} and coated with a rubber composition, the carcass reinforcement extending from one bead to the other, passing through the crown, the carcass reinforcement being anchored in each bead by a turn-up around the said at least one annular reinforcement structure, so as to form an main portion and a wrapped-around portion, the carcass reinforcement being designed so as to satisfy the inequality:

$$\frac{{FB}_{C}}{{P}_{C}} \leq 1.5 \cdot {10}^{6} \cdot \frac{( {R}_{S}^{2} - {R}_{E}^{2} )}{{R}_{T}} ,$$

where FB_{C} is expressed in Newton, R_{S} is the radial distance between the axis of rotation of the tire and the radially outermost point of the carcass reinforcement, R_{E} is the radial distance between the axis of rotation of the tire and the axial position at which the tire reaches its maximum axial width, and R_{T} is the radial distance between the axis of rotation of the tire and the radially innermost point of the said at least one annular reinforcement structure, the pitch P_{C} and the radial distances R_{S}, R_{E} and R_{T} being expressed in metres;

each sidewall of the tire also comprising an additional reinforcement consisting of threadlike reinforcing elements having an elongation at break EB_{A} and a force at break FB_{A}, placed at a pitch P_{A} and coated with a rubber composition, the additional reinforcement extending between a radially inner end that is close to the said at least one annular reinforcement structure of the bead extended by the sidewall, and a radially outer end situated radially between the carcass reinforcement and the crown reinforcement,

wherein EB_{A}, FB_{A}, P_{A}, EB_{C}, FB_{C} and P_{C} are chosen such that

$$\frac{{FB}_{A}}{{P}_{A}} \geq 1.3 \cdot \frac{{FB}_{C}}{{P}_{C}} , \\ and$$

$${EB}_{C} \geq {EB}_{A} ,$$

it being understood that the forces at break FB_{A} and FB_{C}, and the elongations at break EB_{C} and EB_{A} are determined on the reinforcing elements after extraction from the cured tire.

Specifically, the combination of an “under proportioned” carcass reinforcement and an additional reinforcement makes it possible to reduce the cost and the weight of the tire and to increase its strength while giving the designer increased flexibility.

The invention makes it possible to reinforce the carcass reinforcement where it is greatly acted upon (that is to say in the sidewalls) while reducing its strength (and consequently its cost) in the zone where it is only slightly acted upon (that is to say in the crown), contrary to the “shoulder lock” which merely doubles the carcass reinforcement in the sidewall. The invention is therefore all the more advantageous if the sidewall is short and the crown wide, as occurs in certain higher performance, low aspect ratio tires.

According to a first preferred embodiment, the crown reinforcement has, in each radial section, two axial ends and the radially outer end of each of the two additional reinforcements is axially inside the axial end of the closest crown reinforcement, the axial distance between the radially outer end of each additional reinforcement and of the axial end of the closest crown reinforcement being greater than or equal to 10 mm. Thus, the reinforcement is well anchored beneath the crown reinforcement which allows it to properly absorb the tensions and relieve the carcass reinforcement itself.

According to a second preferred embodiment, the radially inner end of each additional reinforcement is radially inside the radially outermost point of the wrapped-around portion of the carcass reinforcement and the radial distance DR between the radially inner end of each additional reinforcement and the radially outermost point of the wrapped-around portion of the carcass reinforcement is greater than or equal to 10 mm. This allows a correct anchoring of the additional reinforcement in the bead and consequently a good absorption of the tensions by the additional reinforcement.

According to a particular embodiment, each additional reinforcement extends, in the bead, along the main portion of the carcass reinforcement. This configuration has the advantage of simplifying the tire manufacturing process.

Conventionally, tires are made by placing plies on a drum, in which case the carcass reinforcement and the additional reinforcement each comprise at least one “weld” where the plies overlap. According to a particular embodiment, the weld of the carcass reinforcement is offset, in the circumferential direction, relative to the weld of the additional reinforcement. This embodiment, which cannot be achieved in an architecture of the “shoulder lock” type, makes it possible to improve the uniformity of the tire.

According to an alternative embodiment, each additional reinforcement extends, in the bead, along the wrapped-around portion of the carcass reinforcement. Thus any contact between the additional reinforcement and the annular reinforcement structure is most certainly avoided, even when the length of the additional reinforcement is too great.

According to a particular embodiment, the reinforcing elements of each additional reinforcement are oriented radially. This design makes it possible to retain the overall compromise of performance associated with the radial structure of the carcass reinforcement (the compromise between comfort, rolling resistance, behaviour etc.) while improving the “pinch shock” performance.

According to another particular embodiment, the reinforcing elements of each additional reinforcement are inclined at an angle of between 40° and 80°, and preferably between 40° and 50°, relative to the radial direction. This design makes it possible to increase the vertical rigidity, which is beneficial for “pinch shock” performance while also orienting the reinforcing elements so as to promote the absorption of longitudinal tensions which improves their resistance to pavement impacts.

Notably, it is possible to make the reinforcing elements of the additional reinforcement of PET, of aramid, of aramid-nylon hybrid cords or else of aramid-PET hybrid cords. Reinforcing elements made of aramid or of hybrid cords are rarely used in the carcass reinforcement because they do not withstand compression very well. The carcass reinforcement is often subjected to compression, above all in tires that have short sidewalls. On the other hand, the additional reinforcement is less subjected to compression, which makes it possible to use these reinforcing elements that are distinguished by their tenacity. The particular advantage of aramid-nylon hybrid cords lies in their high resistance to breakage, that of aramid-PET hybrid cords is that they have the qualities of aramid while having the rigidity of reinforcing elements made of PET.

Naturally, it is possible (and may even be advantageous) to link together several of these embodiments to obtain a particularly high-performance tire.

The invention as described above relates to tires having a turn-up of the carcass reinforcement around an annular reinforcement structure. Naturally, it would be possible to provide an additional reinforcement as described in a tire in which the reinforcement is anchored between a plurality of annular reinforcement structures, such as for example the architectures obtained in the “C3M” method of Michelin, well known to those skilled in the art.

### BRIEF DESCRIPTION OF THE DRAWINGS

FIG. 1 represents a tire according to the prior art.

FIG. 2 represents a partial view in perspective of a tire according to the prior art.

FIG. 3 represents, in radial section, a portion of a reference tire.

FIG. 4 represents, in radial section, a portion of a reference tire having a “shoulder lock” configuration.

FIGS. 5 and 7 represent, in radial section, a portion of a tire according to an embodiment of the invention.

FIG. 6 illustrates the distribution of the tensions between the carcass reinforcement and the additional reinforcement, on the sidewall.

FIG. 8 illustrates certain parameters used to characterize a tire according to an embodiment of the invention.

### DETAILED DESCRIPTION OF THE FIGURES

In the use of the term “radial”, several different uses of the word by those skilled in the art need to be distinguished. First, the expression refers to a radius of the tire. It is in this meaning that it is said that a point P1 is “radially inside” a point P2 (or “radially on the inside” of point P2) if it is closer to the axis of rotation of the tire than point P2. Conversely, a point P3 is said to be “radially outside” a point P4 (or “radially on the outside” of point P4) if it is further from the axis of rotation of the tire than point P4. It will be said that a movement is “radially towards the inside (or the outside)” when the movement is in the direction of the shortest (or longest) radii. When radial distances are referred to, this meaning of the term also applies.

On the other hand, a thread or a reinforcement is called “radial” when the thread or the reinforcing elements of the reinforcement make with the circumferential direction an angle greater than or equal to 80° and less than or equal to 90°. In the present document, the term “thread” should be understood to have the wholly general meaning and includes the threads that take the form of monofilaments, multifilaments, a cord, a folded yarn or an equivalent assembly, irrespective of the material forming the thread or the surface treatment to promote its connection with the rubber. In the present document, the term “threadlike” should be understood to mean a thread as indicated above, or a cord, or other structure having a length much larger than its thickness, and suitable for performing the reinforcement functions described herein.

Finally “radial section” in this instance means a section on a plane that contains the axis of rotation of the tire.

An “axial” direction is a direction parallel to the axis of rotation of the tire. A point P5 is said to be “axially inside” a point P6 (or “axially on the inside” of point P6) if it is closer to the mid-plane of the tire than point P6. Conversely, a point P7 is said to be “axially outside” a point P8 (or “axially on the outside” of point P8) if it is further from the mid-plane of the tire than point P8. The “mid-plane” of the tire is the plane that is perpendicular to the axis of rotation of the tire and that is situated equidistant from the annular reinforcement structures of each bead.

A “circumferential” direction is a direction that is perpendicular both to a radius of the tire and to the axial direction.

In the context of this document, the expression “rubber composition” is a rubber composition comprising at least one elastomer and one filler.

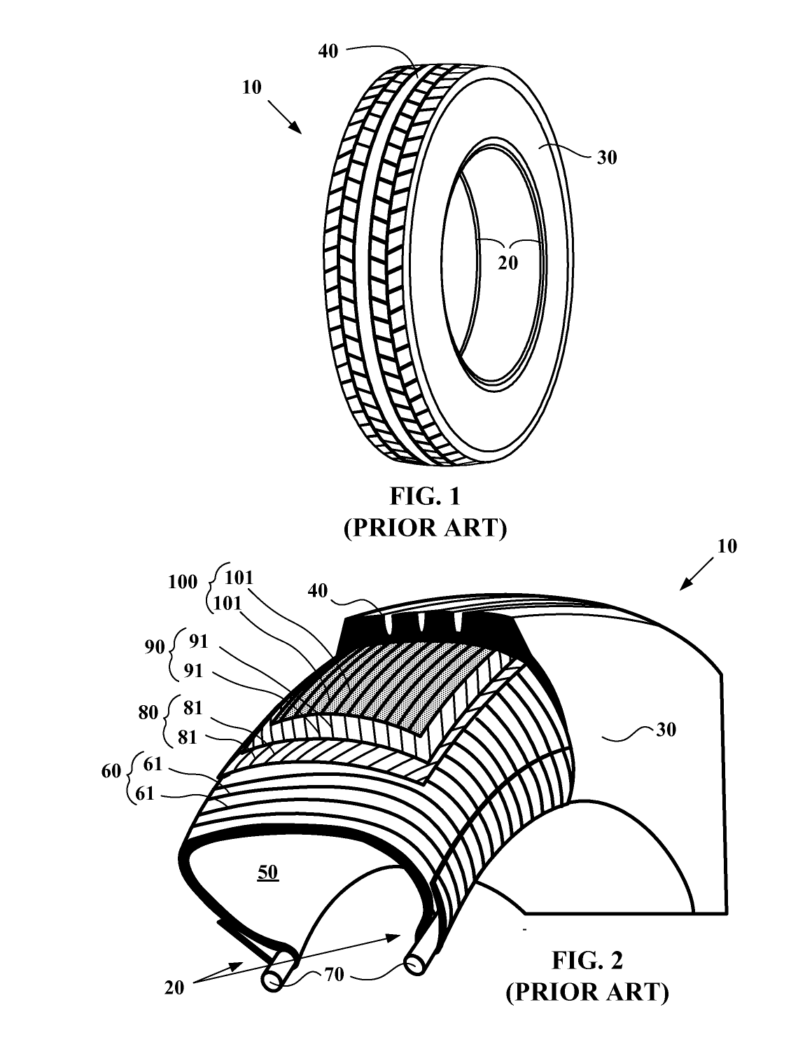

FIG. 1 represents schematically a tire 10 according to the prior art. The tire 10 comprises a crown comprising a crown reinforcement (invisible in FIG. 1) surmounted by a tread 40, two sidewalls 30 extending the crown radially towards the inside, and two beads 20 radially inside the sidewalls 30.

FIG. 2 represents schematically a partial view in perspective of a tire 10 according to the prior art and illustrates the various components of the tire. The tire 10 comprises a carcass reinforcement 60 consisting of threads 61 coated with a rubber composition, and two beads 20 each comprising annular reinforcement structures 70 that keep the tire 10 on the rim (not shown). The carcass reinforcement 60 is anchored in each of the beads 20 by a turn-up. The tire 10 also comprises a crown reinforcement comprising two plies 80 and 90. Each of the plies 80 and 90 is reinforced by threadlike reinforcing elements 81 and 91 that are parallel in each layer and crossed from one layer to another, while making with the circumferential direction angles of between 10° and 70°. The tire also comprises a hooping reinforcement 100 placed radially on the outside of the crown reinforcement, this hooping reinforcement being formed of reinforcing elements 101 oriented circumferentially and wound in a spiral. A tread 40 is placed on the hooping reinforcement; it is this tread 40 that makes the contact of the tire 10 with the road. The tire 10 that is shown is a “tubeless” tire: it comprises an “inner liner” 50 made of a butyl-based rubber composition, impermeable to the inflation gas, covering the internal surface of the tire.

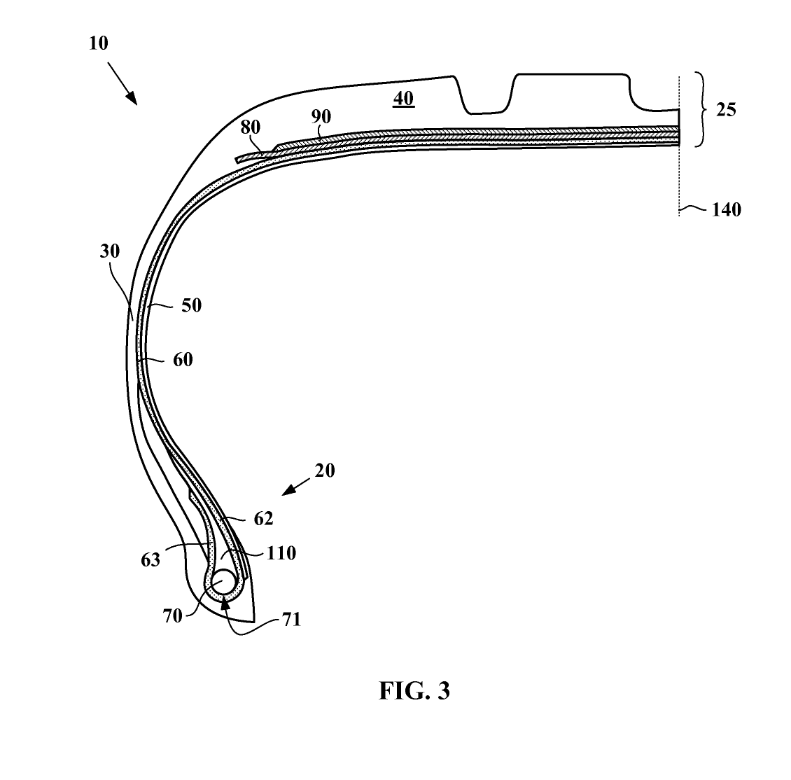

FIG. 3 represents, in radial section, half of a reference tire. This tire has an axis of rotation (not shown) and comprises two beads 20 designed to come into contact with a mounting rim (not shown), each bead comprising an annular reinforcement structure, in this instance a bead wire 70. The radially innermost point of the bead wire bears the reference 71.

The tire comprises two sidewalls 30 extending the beads radially towards the outside, the two sidewalls 30 joining in a crown 25 comprising a crown reinforcement formed by the plies 80 and 90. The crown reinforcement is surmounted by a tread 40. In principle, it would be possible also to provide a hooping reinforcement like the hooping reinforcement 100 of the tire shown in FIG. 2, but in this instance an attempt has been made to minimize the weight of the tire by providing no hooping reinforcement.

The tire comprises only one radial carcass reinforcement 60 extending from the beads 20 across the side walls 30 to the crown, the carcass reinforcement 60 comprising a plurality of carcass reinforcing elements. It is anchored in the two beads 20 by a turn-up around the bead wire 70 so as to form an main portion 62 and a wrapped-around portion 63. The filling 110 formed of a rubber composition fills the volume between the main portion 62 and the wrapped-around portion 63.

The mid-plane of the tire is indicated using reference 140.

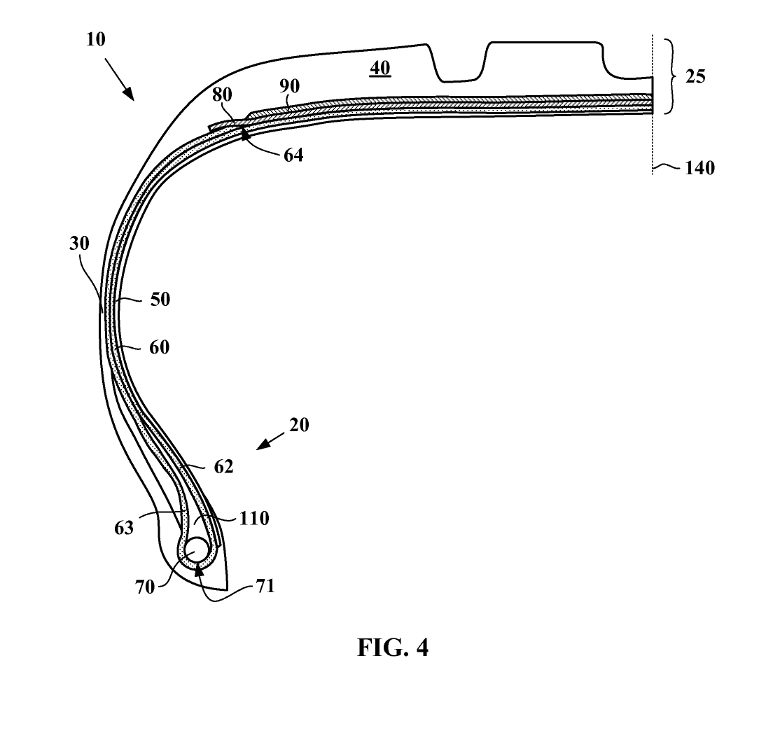

FIG. 4 represents, in radial section, a portion of another reference tire having a “shoulder lock” configuration. Unlike the tire shown in FIG. 3, the wrapped-around portion 63 does not terminate in the bead but extends up to the crown. Its radially outer end 64 is housed between the ply 80 of the crown reinforcement and the main portion 62 of the carcass reinforcement. Thus, the carcass reinforcement 60 is doubled in the whole bead 20 and the sidewall 30, which significantly increases the resistance of the tire to “pinch shock” phenomena.

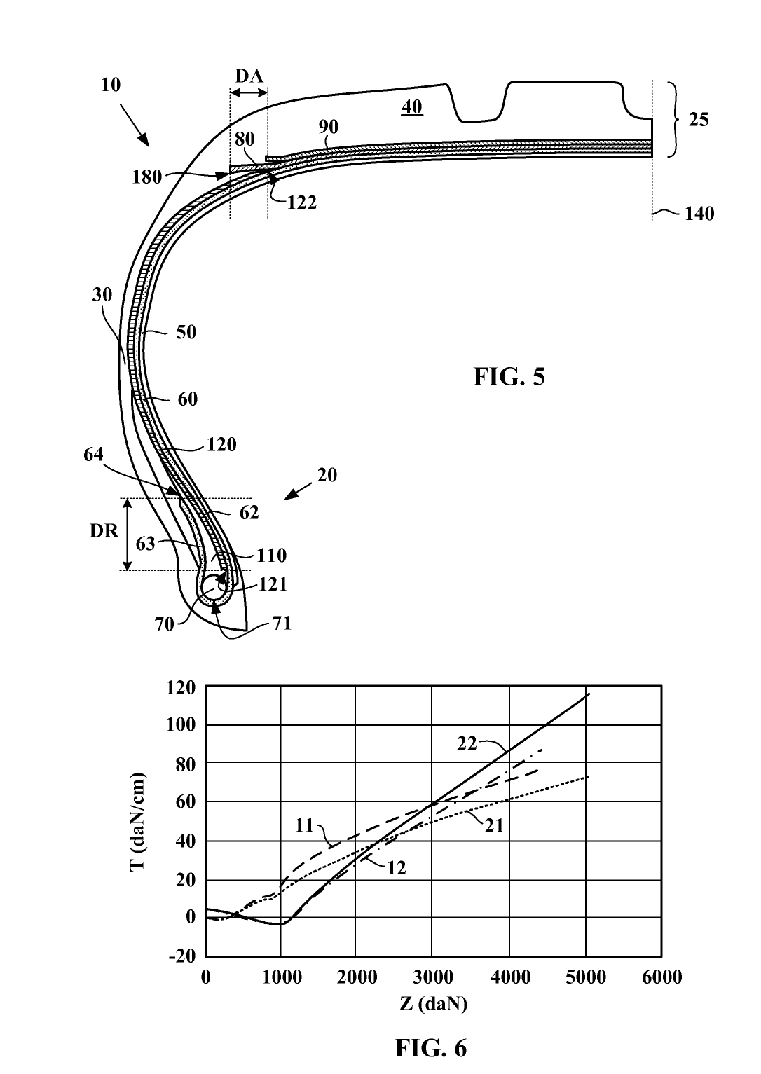

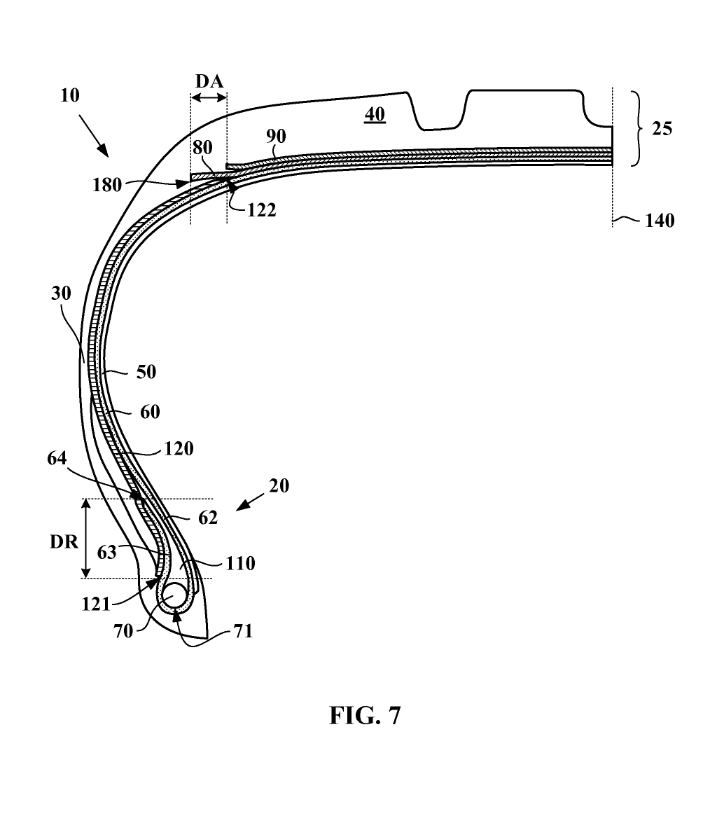

The drawback of this architecture is that it is costly—because it requires using the same reinforcement in the sidewalls and in the crown, although it would be possible to lighten the carcass reinforcement in the crown—while not allowing a very fine adjustment of the performance of the tire. The tire according to the invention of which two embodiments are shown in FIGS. 5 and 7 makes it possible to overcome these drawbacks.

The tire according to an embodiment of the invention of FIG. 5 comprises two beads 20 (of which only one is shown) designed to come into contact with a mounting rim (not shown), each bead comprising an annular reinforcement structure, in this instance a bead wire 70 having a point 71 that is radially innermost. It also comprises two sidewalls 30 extending the beads 20 radially towards the outside, the two sidewalls joining in a crown 25 comprising a crown reinforcement formed by the two plies 80 and 90 and radially surmounted by a tread 40. A radial carcass reinforcement 60 formed of threadlike reinforcing elements having an elongation at break EB_{C} and a force at break FB_{C} and coated with a rubber composition, extends from one bead 20 to the other, passing through the crown 25. The carcass reinforcement 60 is anchored in each bead 20 by a turn-up around the bead wire 70 so as to form a main portion 62 and a wrapped-around portion 63. It is designed to satisfy the inequality:

$$\frac{{FB}_{C}}{{P}_{C}} \leq 1.5 \cdot {10}^{6} \cdot \frac{( {R}_{S}^{2} - {R}_{E}^{2} )}{{R}_{T}} .$$

P_{C} is the pitch of the reinforcing elements of the carcass reinforcement (that is to say 1 divided by the number of reinforcing elements per metre and therefore expressed in metres) in the vicinity of the bead wire 70; the force at break FB_{C} is expressed in Newton.

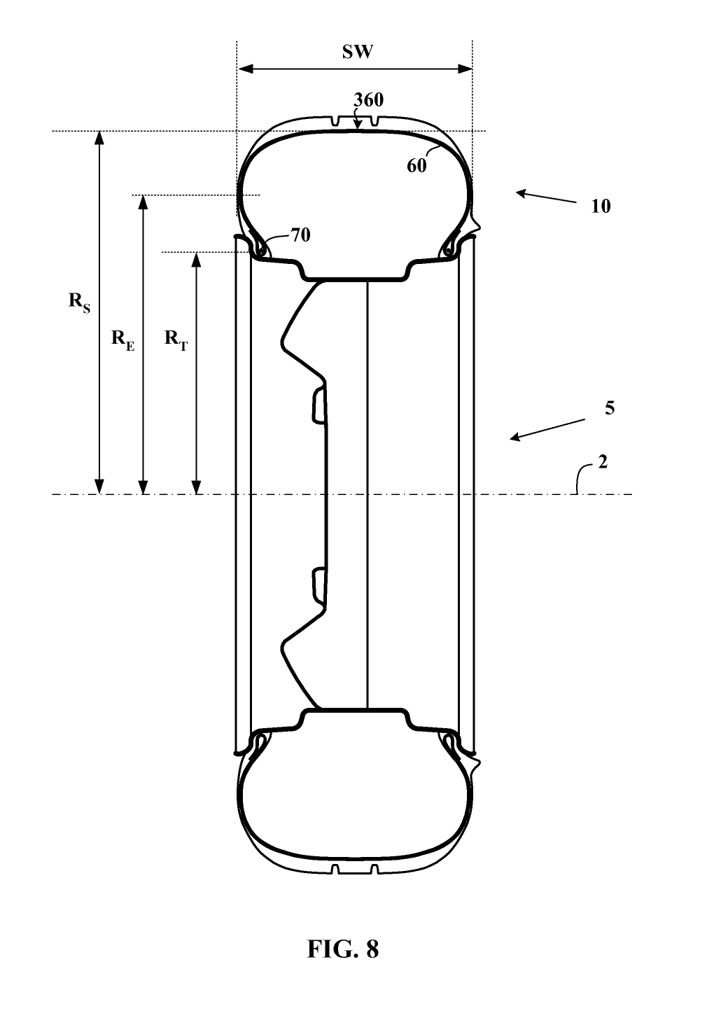

The meaning of the parameters R_{S}, R_{E} and R_{T} is illustrated in FIG. 8. R_{S} is the radial distance between the axis of rotation 2 of the tire 10 and the radially outermost point 360 of the carcass reinforcement 60, R_{E} is the radial distance between the axis of rotation 2 and the axial position in which the tire reaches its maximum axial width SW, and R_{T} is the radial distance between the axis of rotation 2 and the radially innermost point 71 of the bead wire 70 (indicated in FIG. 5). The radial distances R_{S}, R_{E} and R_{T} are expressed in metres.

As suggested in FIG. 5, each sidewall 30 of the tire 10 according to an embodiment of the invention comprises an additional reinforcement 120 consisting of threadlike reinforcing elements having an elongation at break EB_{A} and a force at break FB_{A} placed at a pitch P_{A} and coated with a rubber composition, the additional reinforcement extending between a radially inner end 121 that is close to the bead wire 70 and a radially outer end 122 situated radially between the carcass reinforcement and the crown reinforcement. FB_{A}, P_{A}, FB_{C} and P_{C} are chosen such that

$$\frac{{FB}_{A}}{{P}_{A}} \geq 1.3 \cdot \frac{{FB}_{C}}{{P}_{C}} .$$

This difference in the break forces can be obtained by various means known per se to those skilled in the art. It is possible notably to vary the size, the torsion, the material or else the heat treatment undergone by the reinforcing elements in order to obtain the required difference.

The elongation at break EB_{C} of the reinforcing elements of the carcass reinforcement is greater than or equal to an elongation at break EB_{A} of the reinforcing elements of each of the additional reinforcements (EB_{C}≧EB_{A}).

The forces at break FB_{A} and FB_{C} and the elongations at break EB_{C} and EB_{A} are determined on the reinforcing elements after extraction from the cured tire.

To do this, the inner liner 50 of the tire (see FIG. 5) is removed and the reinforcing elements are torn from the tire taking care not to damage them. The use of solvents should be avoided, which means that the reinforcing elements remain partially coated with rubber composition. When the reinforcing elements are made of rayon, they are dried for 120±15 min at a temperature of 105±4.5° C. Then, the reinforcing elements are conditioned at 23±2° C. at a relative humidity of 27±10% for a period that depends on the nature of the elements:
rayon: at least 5 days and at most 15 days;
nylon and nylon-based hybrids: at least 3 days;
other (notably PET and aramids): at least 1 day.

Then the force at break and the elongation at break are measured; this is done in a manner well known to those skilled in the art with the aid of an “INSTRON” tensioning machine (see also the ASTM D 885-06 standard). The tested samples undergo tensioning over an initial length L0 (in mm) at a nominal speed of L0 mm/min, under a standard pre-tension of 1 cN/tex (the average for at least 10 measurements). The force at break that is retained is the maximum measured force.

It is noted that the values measured after extraction are most frequently fairly close to the values that are obtained on the reinforcing elements before they are incorporated into the tire so that the choice of appropriate reinforcing elements making it possible to obtain certain values after extraction of the tire poses no problem to those skilled in the art.

The crown reinforcement has, in each radial section, two axial ends 180 (of which only one is shown). The radially outer end 122 of each of the two additional reinforcements 120 is axially on the inside of the axial end of the closest crown reinforcement, the axial distance DA between the radially outer end 122 of each additional reinforcement and the axial end 180 of the closest crown reinforcement being in this instance equal to 10 mm.

The radially inner end 121 of the additional reinforcement 120 is radially inside the point 64 that is radially outermost of the wrapped-around portion 63 of the carcass reinforcement 60 and the radial distance DR between the radially inner end 121 of the additional reinforcement 120 and the radially outermost point 71 of the wrapped-around portion 63 of the carcass reinforcement 60 is in this instance equal to 16 mm.

In the tire according to an embodiment of the invention shown in FIG. 5, each additional reinforcement 120 extends, in the bead 20, along the main portion 62 of the carcass reinforcement 60. This is not an essential feature of the invention; it is perfectly possible to provide that each additional reinforcement 120 extends, in the bead 20, along the wrapped-around portion 63 of the carcass reinforcement, as shown in FIG. 7.

In the tires shown in FIGS. 5 and 7, the reinforcing elements of each additional reinforcement 120 are oriented radially, but it is equally possible to use additional reinforcements 120 of which the reinforcing elements are inclined at an angle of between 40° and 80° and preferably between 40° and 50° relative to the radial direction.

The reinforcing elements of the additional reinforcement 120 of the tires shown in FIGS. 5 and 7 are made of PET, but other choices are possible, such as for example cords made of aramid, aramid-nylon hybrid cords or else aramid-PET hybrid cords.

FIG. 6 shows results of calculations concerning a tire sidewall subjected to great deformations. The distributed tension T (in daN/cm) is drawn as a function of the load Z (in daN). The curves 11 and 12 correspond to the reference tire of FIG. 4 (“shoulder lock” configuration). The carcass reinforcement comprises 220×2 reinforcing elements (each reinforcing element consists of two threads each having a linear density of 200 tex) in PET. The force at break of each reinforcing element is 268 daN/cm, which means that the total force at break is equal to 528 daN/cm. The curve 11 shows the tension absorbed by the reinforcing elements of the main portion 62 of the carcass reinforcement, the curve 12 shows that absorbed by the reinforcing elements of the wrapped-around portion 63. It is found that, when the load is considerable, it is the reinforcing elements of the wrapped-around portion that absorb more tension. The curves 21 and 22 correspond to the tire of FIG. 5. The carcass reinforcement comprises 144×2 reinforcing elements in PET. The force at break of each reinforcing element is 187 daN/cm. The additional reinforcement comprises 334×2 reinforcing elements in PET. The force at break of each reinforcing element is 328 daN/cm. The total force at break is therefore equal to 515 daN/cm. The curve 21 represents the tension absorbed by the reinforcing elements of the carcass reinforcement 60, the curve 22 shows that absorbed by the reinforcing elements of the additional reinforcement 120. Although the total force at break is less, the tire according to an embodiment of the invention breaks at significantly higher loads than the reference tire, which clearly illustrates the value of linking an “under proportioned” carcass reinforcement with an additional reinforcement the force at break of which is greater.

These calculation results have subsequently been confirmed by tire tests.

1. A tire having an axis of rotation and comprising:
two beads configured to come into contact with a mounting rim, each bead comprising at least one annular reinforcement structure having a point that is radially innermost;
two sidewalls extending the beads radially outwards, the two sidewalls coming together in a crown comprising a crown reinforcement radially surmounted by a tread;
a radial carcass reinforcement comprised of threadlike reinforcing elements having an elongation at break EB_{C} and a force at break FB_{C}, placed at a pitch P_{c} and coated with a rubber composition, the carcass reinforcement extending from one bead to the other, passing through the crown, the carcass reinforcement being anchored in each bead by a turn-up around said at least one annular reinforcement structure, so as to form a main portion and a wrapped-around portion, the carcass reinforcement being configured so as to satisfy the relationship:
$$\frac{{FB}_{C}}{{P}_{C}} \leq 1.5 \cdot {10}^{6} \cdot \frac{( {R}_{S}^{2} - {R}_{E}^{2} )}{{R}_{T}} ,$$
where FB_{C} is expressed in Newton, R_{S} is the radial distance between the axis of rotation of the tire and the radially outermost point of the carcass reinforcement, R_{E} is the radial distance between the axis of rotation of the tire and the axial position at which the tire reaches its maximum axial width, and R_{T} is the radial distance between the axis of rotation of the tire and the radially innermost point of the said at least one annular reinforcement structure, the pitch P_{c} and the radial distances R_{S}, R_{E} and R_{T} being expressed in metres; and
each sidewall of the tire also comprising an additional reinforcement comprised of threadlike reinforcing elements having an elongation at break EB_{A} and a force at break FB_{A}, placed at a pitch P_{A} and coated with a rubber composition, the additional reinforcement extending between a radially inner end that is close to the said at least one annular reinforcement structure of the bead extended by the sidewall, and a radially outer end situated radially between the carcass reinforcement and the crown reinforcement,
wherein EB_{A}, FB_{A}, P_{A}, EB_{C}, FB_{C} and P_{C} satisfy the relationships:
$$\frac{{FB}_{A}}{{P}_{A}} \geq 1.3 \cdot \frac{{FB}_{C}}{{P}_{C}} , \\ and$$
$${EB}_{C} \geq {EB}_{A} ,$$
wherein the forces at break FB_{A} and FB_{C}, and the elongations at break EB_{C} and EB_{A} are determined on the reinforcing elements after extraction from the cured tire.

2. The tire according to claim 1, wherein the crown reinforcement has, in each radial section, two axial ends and wherein the radially outer end of each of the two additional reinforcements is axially inside the axial end of the closest crown reinforcement, the axial distance between the radially outer end of each additional reinforcement and of the axial end of the closest crown reinforcement being greater than or equal to 10 mm.

3. The tire according to claim 1, wherein the radially inner end of each additional reinforcement is radially inside the radially outermost point of the wrapped-around portion of the carcass reinforcement and the radial distance between the radially inner end of each additional reinforcement and the radially outermost point of the wrapped-around portion of the carcass reinforcement is greater than or equal to 10 mm.

4. The tire according to claim 1, wherein each additional reinforcement extends, in the bead, along the main portion of the carcass reinforcement.

5. The tire according to claim 4, wherein the carcass reinforcement and the additional reinforcement each comprise at least one weld and wherein the weld of the carcass reinforcement is offset, in the circumferential direction, relative to the weld of the additional reinforcement.

6. The tire according to claim 1, wherein each additional reinforcement extends, in the bead, along the wrapped-around portion of the carcass reinforcement.

7. The tire according to claim 1, wherein the reinforcing elements of each additional reinforcement are oriented radially.

8. The tire according to claim 1, wherein the reinforcing elements of each additional reinforcement are inclined at an angle of between 40° and 80° relative to the radial direction.

9. The tire according to claim 1, wherein the reinforcing elements of the additional reinforcement are made of PET.

10. The tire according to claim 1, wherein the reinforcing elements of the additional reinforcement are aramid-nylon hybrid cords.

11. The tire according to claim 1, wherein the reinforcing elements of the additional reinforcement are aramid cords or aramid-PET hybrid cords.

12. The tire according to claim 1, wherein the reinforcing elements of each additional reinforcement are inclined at an angle of between 40° and 50° relative to the radial direction.
